(19) United States
(12) Patent Application Publication
(10) Pub. No.: US 2023/0318512 A1
(43) Pub. Date: Oct. 5, 2023

(54) MOTOR DEVICE, GEAR MOTOR, DETECTION METHOD, AND COMPUTER READABLE MEDIUM

(71) Applicant: Tsubakimoto Chain Co., Osaka-shi, Osaka (JP)

(72) Inventors: Yoshiaki Yokoi, Osaka-shi, Osaka (JP); Haruki Teramukai, Osaka-shi, Osaka (JP)

(73) Assignee: Tsubakimoto Chain Co., Osaka-shi, Osaka (JP)

(21) Appl. No.: 18/020,842

(22) PCT Filed: Aug. 2, 2021
(86) PCT No.: PCT/JP2021/028630

§ 371 Date: Feb. 10, 2023

(30) Foreign Application Priority Data
Aug. 31, 2020 (JP) 2020-146214

(51) Int. Cl. H02P 29/024; H02P 29/028; H02P 29/60

(52) U.S. Cl. CPC H02P 29/026; H02P 29/028; H02P 29/60

(57) ABSTRACT

Provided are a motor device, a gear motor, a detection method, and a computer readable medium capable of detecting a load fluctuation and performing highly accurate preventive maintenance. The motor device comprises: a motor; a power detection circuit that detects power supplied to the motor; a temperature sensor that measures a temperature of the motor; a storage unit that stores a regression equation expressing a relationship between power detected by the power detection circuit and a temperature measured by the temperature sensor, and a physical quantity used to derive an output shaft torque of the motor; and a processing unit that derives the output shaft torque of the motor from the power detected by the power detection circuit and the temperature measured by the temperature sensor by using the physical quantity obtained by the regression equation.

### CROSS-REFERENCE TO RELATED APPLICATIONS

This application is the national phase under 35 U. S. C. §371 of PCT International Application No. PCT/JP2021/028630 which has an International filing date of Aug. 2, 2021 and designated the United States of America.

### FIELD

The present invention relates to a motor device, a gear motor, a detection method, and a computer readable medium storing a computer program which are capable of detecting a load fluctuation and performing highly accurate preventive maintenance.

### BACKGROUND

When motors used in various parts of production sites stop due to overload, an operation rate drops. Therefore, a device that uses a motor is provided with an overload protection circuit that detects an overload state of the motor and stops the motor, and performs preventive maintenance to prevent operation in the overload state.

Conventional art include a gear motor that performs overload protection in which overload is detected by a current to a motor. However, in a case where load is light, a current value does not fluctuate, and thus load abnormality may not be detected.

Therefore, the other conventional art discloses a configuration that uses a power detection circuit to which a current value and a voltage value are input and from which power is output, and the overload state is detected by comparison between a power value and a threshold value.

It cannot be said that power supplied to a motor gently fluctuates, for example, when power is supplied through an inverter, and in a device that uses the motor, a temperature also varies in correspondence with operation time, and the power may also vary. It is required to detect overload with accuracy in correspondence with various operation conditions in production sites where the motor device is used.

An object of the invention is to provide a motor device, a gear motor, a detection method, and a computer readable medium storing a computer program which are capable of detecting a load fluctuation and performing highly accurate preventive maintenance.

According to an embodiment of the present disclosure, there is provided a motor device including: a motor; a power detection circuit configured to detect power supplied to the motor from a power supply; a temperature sensor configured to measure a temperature; a storage unit configured to store a regression equation representing a relationship between power detected by the power detection circuit and a temperature measured by the temperature sensor, and a physical quantity used to derive an output shaft torque of the motor; and a processing unit configured to derive the output shaft torque of the motor from the power detected by the power detection circuit and the temperature measured by the temperature sensor by using the physical quantity obtained by the regression equation.

According to an embodiment of the present disclosure, there is provided a detection method including: acquiring power supplied from a power supply to a motor; acquiring a temperature of the motor; storing a regression equation representing a relationship between the power supplied to the motor and the temperature of the motor, and a physical quantity used to derive an output shaft torque of the motor; deriving the output shaft torque of the motor from the acquired power and the acquired temperature by using the regression equation; determining whether or not the derived output shaft torque is equal to or greater than a determination reference value, or equal to or less than the determination reference value; detecting that the motor is in an overload state in a case where the output shaft torque is determined as being equal to or greater than the determination reference value; and detecting that the motor is in a light load state in a case where the output shaft torque is determined as being equal to or less than the determination reference value.

According to an embodiment of the present disclosure, there is provided a computer product storing a computer program of detecting a motor load state. The computer program causes a computer to execute processes of: acquiring power supplied from a power supply to a motor; acquiring a temperature; storing a regression equation representing a relationship between the power supplied to the motor and the temperature of the motor, and a physical quantity used to derive an output shaft torque of the motor; and deriving the output shaft torque of the motor from the acquired power and the acquired temperature by using a physical quantity obtained by the regression equation.

In the motor device, the detection method, and the computer product of the present disclosure, a determination is made on the basis of a calculation value corresponding to a motor load calculated on the basis of the power that is input to the motor and the temperature. A consideration is made to a relationship with not only power depending on a device temperature that varies in correspondence with operation time but also a temperature. Since a determination is made by a torque corresponding to an estimated motor load, overload or light load can be detected with more accuracy.

In the motor device according to the embodiment of the present disclosure, the regression equation includes a first regression equation representing a relationship between power detected by the power detection circuit, and a load rate of the motor, a second regression equation representing a relationship between the load rate and motor efficiency of the motor, and a third regression equation representing a relationship between the load rate and a rotation rate with respect to a synchronous rotation speed of the motor, and the processing unit derives the output shaft torque of the motor by using motor efficiency obtained from power detected by the power detection circuit on the basis of the second regression equation, and a motor output obtained from the motor efficiency, and a rotation rate obtained from the power on the basis of the third regression equation, and a rotation speed of the output shaft of the motor which is obtained by the rotation rate.

In the motor device of the present disclosure, the regression equation includes the first regression equation for deriving a motor load rate having high correlation with input power, the second regression equation representing a relationship between the load rate of the motor and the motor efficiency, and the third regression equation representing a relationship between the load rate of the motor and a rotation rate of the motor (an actual rotation speed/a synchronous rotation speed of the motor). The processing unit can obtain an actual rotation speed and a motor output which are necessary to derive an output shaft torque of the motor from input power.

In the motor device of the embodiment of the present disclosure, one or a plurality of the first to third regression equations uses a power supply frequency of the power supply which is specified on the basis of a signal detected by a current detection unit included in the power detection circuit.

In the motor device of the present disclosure, the power supply frequency may be used to derive the load rate, the motor efficiency, and the rotation rate of the motor of which relationships are described by the first to third regression equations. Derivation can be performed in consideration of fluctuations of the load rate, the efficiency, and the rotation rate of the motor in accordance with 50 Hz/60 Hz that is a power supply frequency, or a power supply frequency converted by an inverter, and overload can be detected with more accuracy.

In the motor device of the embodiment of the present disclosure, the processing unit compares the derived output shaft torque of the motor and a determination reference value with each other, and stops the motor in a case where the output shaft torque is determined as being equal to or greater than the determination reference value or equal to or less than the determination reference value.

In the motor device of the present disclosure, it is possible to detect overload or light load by the magnitude of the output shaft torque of the motor (or a gear output torque) corresponding to the motor load and it is possible to protect the motor by stopping the motor.

The motor device of the embodiment of the present disclosure further includes a communication unit. The processing unit compares the derived output shaft torque of the motor and a determination reference value with each other, and notifies the outside of an overload state or a light load state of the motor in combination with data representing an excessive or insufficient output shaft torque by the communication unit in a case where the output shaft torque is determined as being equal to or greater than the determination reference value or equal to or less than the determination reference value.

In the motor device of the present disclosure, the outside is notified of stoppage of the motor based on the excessive or insufficient torque. It becomes clear that an overload state or a light load state is detected on the basis of an estimated torque (an output shaft torque of a motor, or an output shaft torque of a reduction gear) rather than a directly detected physical quantity such as a current value, voltage value, a temperature, or a power value.

In the motor device of the embodiment of the present disclosure, the processing unit accepts setting of the determination reference value.

In the motor device of the present disclosure, setting of the determination reference value that is compared with a derived torque is accepted from the outside. The reference value for detecting the overload state or the light load state can be appropriately set in correspondence with a model of the motor in the motor device, use environments in which the motor device is used, and use conditions, and the motor device can be used for intended purpose.

The motor device of the embodiment of the present disclosure further includes a communication unit. The processing unit notifies the outside of data corresponding to the magnitude of the derived output shaft torque of the motor by the communication unit.

In the motor device of the present disclosure, since the outside is constantly notified of data representing a value corresponding to the magnitude of the derived torque, an upper-layer control device can use the data to estimate a state of the motor device.

According to an embodiment of the present disclosure, there is provided a gear motor including: a motor; a reduction gear that reduces and outputs rotation of the motor; a power detection circuit that detects power supplied to the motor from a power supply; a temperature sensor that measures a temperature; a storage unit that stores a regression equation representing a relationship between power detected by the power detection circuit or a temperature measured by the temperature sensor, and a physical quantity used to derive a gear output shaft torque of the reduction gear; and a processing unit that derives the gear output shaft torque of the reduction gear from the power detected by the power detection circuit or the temperature measured by the temperature sensor by using the physical quantity obtained by the regression equation.

In the gear motor of the present disclosure, a determination is made on the basis of a calculation value corresponding to a motor load calculated on the basis of power input to the motor and a temperature. A consideration is made to a relationship with not only power depending on a device temperature that varies in correspondence with operation time but also a temperature. Since a determination is made by a torque corresponding to an estimated motor load, overload or light load can be detected with more accuracy.

In the gear motor of the embodiment of the present disclosure, the regression equation may include a fourth regression equation representing a relationship between a temperature measured by the temperature sensor, and a gear grease temperature of the reduction gear, and the processing unit may derive the output shaft torque of the reduction gear by deriving the gear grease temperature from a temperature measured by the temperature sensor by using the fourth regression equation.

In the gear motor of the present disclosure, the regression equation includes a regression equation representing a relationship between a temperature measured by the temperature sensor, and the gear grease temperature of the reduction gear which is difficult to measure during operation of the motor. The processing unit can derive motor efficiency, a loss, and the like which fluctuate in accordance with a temperature variation with accuracy.

In the gear motor of the embodiment of the present disclosure, the temperature sensor is accommodated in a box attached to an exterior package of the motor, and the fourth regression equation is a regression equation representing a relationship between an inner temperature of the box and the grease temperature.

In the gear motor of the present disclosure, the temperature sensor measures a temperature inside the box attached to the exterior package of the motor. Since a relationship between the temperature measured by the temperature sensor and the grease temperature is measured in advance and is stored as the regression equation, the processing unit can derive the grease temperature.

In the gear motor of the embodiment of the present disclosure, the regression equation may include a fifth regression equation representing a relationship between a temperature of the motor, and a no-load torque of the reduction gear, and the processing unit may derive the output shaft torque of the reduction gear by using a no-load loss of the motor which is obtained by the no-load torque obtained from the temperature by using the fifth regression equation and a rotation speed of the motor, a motor output obtained on the basis of power detected by the power detection circuit, and a rotation speed of an output shaft of the motor.

In the gear motor of the present disclosure, the regression equation includes a regression equation representing a relationship between the temperature of the motor and the no-load torque of the gear. The processing unit can derive the no-load torque of the gear from the temperature by the fifth regression equation, and can estimate a value corresponding to the output shaft torque of the reduction gear in combination with other physical quantities such as a rotation speed and a motor speed.

In the gear motor of the embodiment of the present disclosure, the fifth regression equation may include a plurality of regression equations representing different relationships in accordance with a model of the motor, and the processing unit may select the fifth regression equation in correspondence with the model of the motor.

In the gear motor of the present disclosure, since the relationship between the temperature and the no-load torque of the gear, which is represented by the fifth regression equation, is different depending on models different in the number of revolutions, a frequency, and the like, the regression equation is appropriately selected in correspondence with the model of the motor.

According to the present disclosure, a load can be detected without depending on a temperature, and highly accurate preventive maintenance can be performed.

The above and further objects and features of the invention will more fully be apparent from the following detailed description with accompanying drawings.

### BRIEF DESCRIPTION OF THE DRAWINGS

FIG. 1 is a schematic perspective view of a motor device.

FIG. 2 is a block diagram illustrating a configuration of a protection unit.

FIG. 3 is a circuit diagram illustrating an example of a power detection circuit.

FIG. 4A is a view schematically illustrating a regression equation stored in a storage unit.

FIG. 4B is a view schematically illustrating a regression equation stored in the storage unit.

FIG. 4C is a view schematically illustrating a regression equation stored in the storage unit.

FIG. 4D is a view schematically illustrating a regression equation stored in the storage unit.

FIG. 4E is a view schematically illustrating a regression equation stored in the storage unit.

FIG. 5 is a flowchart illustrating an example of an overload detection procedure in a control unit of the protection unit.

FIG. 6 is a flowchart illustrating an example of the overload detection procedure in the control unit of the protection unit.

FIG. 7 is a graph illustrating an example of input power of a motor, a gear grease temperature, and a gear output shaft torque with passage of time.

FIG. 8 is a flowchart illustrating an example of a procedure of accepting a determination reference value setting in the control unit.

FIG. 9 is a view illustrating an example of a determination reference value setting accepting screen.

### DETAILED DESCRIPTION

### Mode for Carrying Out Invention

The present disclosure will be described in detail with reference to the accompanying drawings illustrating embodiments of the present disclosure. In the following embodiments, description will be made with reference to a gear motor to which a motor device of the present disclosure is applied.

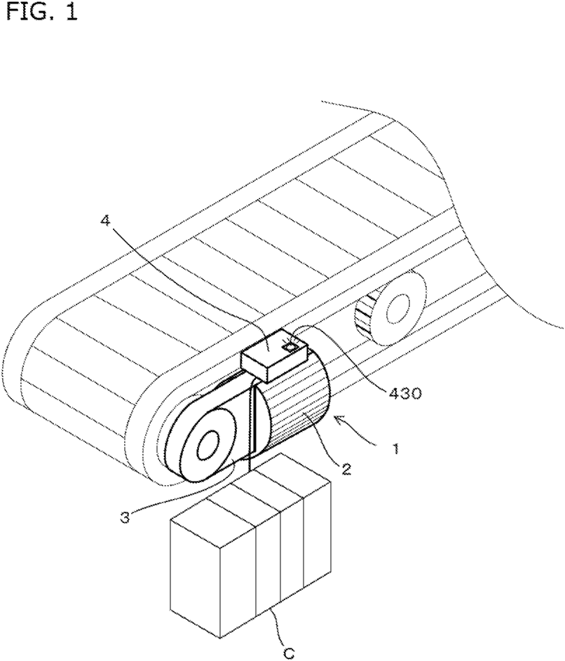

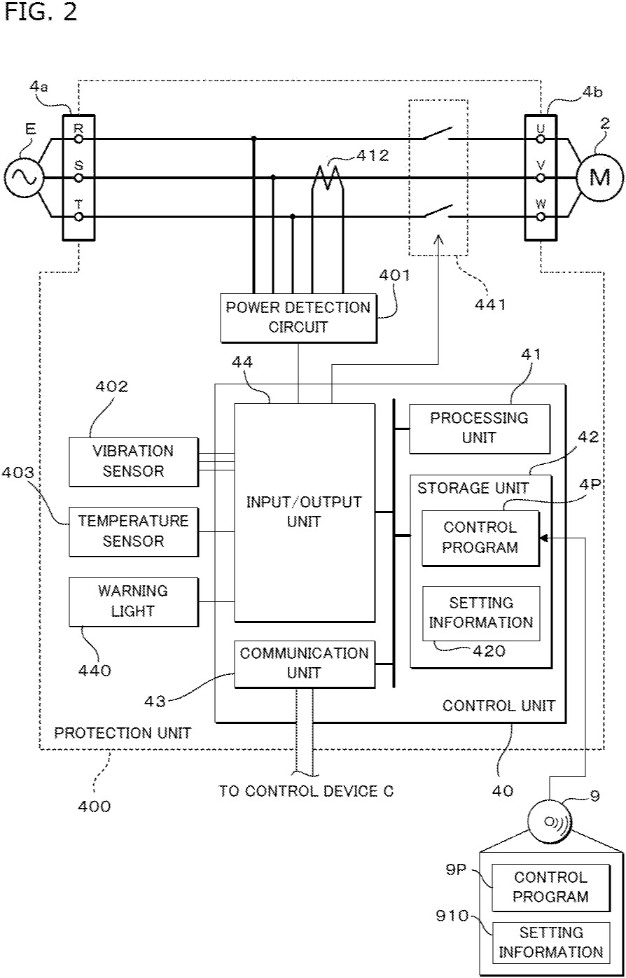

FIG. 1 is a schematic perspective view of a motor device 1. As described above, the motor device 1 is a gear motor. For example, as illustrated in FIG. 1, the motor device 1 is assembled to rotate a sprocket of a belt conveyor. The motor device 1 includes a motor 2, a reduction gear 3, and a protection unit 400 (refer to FIG. 2) accommodated in a terminal box 4.

The motor 2 includes a three-phase coil, a rotor that rotates with an alternating current flowing to the three-phase coil, and a rotating shaft that outputs a torque of the rotor.

The reduction gear 3 is connected to the rotating shaft of the motor 2, and includes a gear mechanism that reduces rotation of the rotation shaft and outputs a torque of the motor 2, and an output shaft. For example, the gear mechanism is a known reduction gear mechanism such as a helical gear mechanism, a hypoid gear mechanism, and a worm gear mechanism.

The terminal box 4 is an approximately parallelepiped rectangular box that accommodates various terminals related to operation of the motor 2. The terminal box 4 is provided on any one site among side surfaces of the motor 2. The terminal box 4 is provided with the protection unit 400 that detects overload of the motor device 1 and detects abnormality thereof based on a temperature, vibration, and the like, and stops the motor 2 in a case where overload or light load, and the abnormality are detected. The protection unit 400 is connected in a manner capable of communicating with a control device C that controls operation of the motor device 1.

The protection unit 400 includes a warning light 440 that is turned on in a case of detecting overload, light load, or the abnormality. The warning light 440 is provided to be exposed from the terminal box 4.

FIG. 2 is a block diagram illustrating a configuration of the protection unit 400. The protection unit 400 includes a control unit 40, a power detection circuit 401, a vibration sensor 402, and a temperature sensor 403. All of the control unit 40, the power detection circuit 401, the vibration sensor 402, and the temperature sensor 403 are accommodated in the terminal box 4.

The control unit 40 is a microcontroller. The control unit 40 may be constituted by a dedicated LSI, or an FPGA. The control unit 40 is connected to other members such as the power detection circuit 401, the vibration sensor 402, and the temperature sensor 403 included in the protection unit 400. The control unit 40 protects the motor 2 on the basis of a detection value and a measurement value obtained from the power detection circuit 401, the vibration sensor 402, and the temperature sensor 403.

The control unit 40 includes a processing unit 41, a storage unit 42, a communication unit 43, and an input/output unit 44. The processing unit 41 includes a central processing unit (CPU), a timer, and a random access memory (RAM). The control unit 40 may use a programmable logic controller (PLC). The processing unit 41 executes the following processing on the basis of a control program 4P and setting information 420 stored in the storage unit 42.

The storage unit 42 (computer program product) uses a nonvolatile memory such as a flash memory. The control program 4P and the setting information 420 are stored in the storage unit 42. The control program 4P may be a control program 9P that is stored in a computer readable storage medium 9 (computer program product) and is read out by the processing unit 41 and stored in the storage unit 42. The control program 4P may be stored after being downloaded from a program server (not illustrated). The setting information 420 may be setting information 910 that is stored in the storage medium 9 and is read out by the processing unit 41 and stored in the storage unit 42.

The setting information 420 stored in the storage unit 42 includes a regression equation. The regression equation is different depending on a model of the motor device 1, for example, the type of the reduction gear 3, and is stored in advance through the communication unit 43 or the input/output unit 44. Details of the regression equation will be described later.

The communication unit 43 is an interface that realizes communication with a control device C or other external devices (for example, a maintenance device). For example, the communication unit 43 is an interface that realizes bus communication for PLC.

The input/output unit 44 is an input/output interface of the processing unit 41. The processing unit 41 acquires signals output from the power detection circuit 401, the vibration sensor 402, and the temperature sensor 403 through the input/output unit 44. The processing unit 41 outputs signals to the warning light 440 and a cut-off switch 441 through the input/output unit 44.

The power detection circuit 401 is an arithmetic operation circuit that calculates power input from an AC power supply E to the motor 2 from a current value and a voltage value, and outputs the resultant value. The power detection circuit 401 is connected to a contact between a three-phase power supply connection terminal 4a connected to the AC power supply E and a motor connection terminal 4b connected to the motor 2, and measures a voltage and a current. Details of the power detection circuit 401 will be described later.

As the vibration sensor 402, an acceleration sensor or the like is used. The vibration sensor 402 is provided inside the terminal box 4. The terminal box 4 is directly attached to the side surface of the motor 2 of the gear motor that is a detection target, and thus vibration in the motor 2 is output as a voltage signal.

As the temperature sensor 403, a thermistor is used. The temperature sensor 403 is provided inside the terminal box 4. The terminal box 4 is attached to the side surface of the motor 2 of the gear motor that is a detection target, and thus the temperature sensor 403 measures a temperature conducted from the casing outer surface of the motor 2 and outputs a signal level corresponding to the temperature.

As the warning light 440, a lamp such as an LED is used. The warning light 440 shows a state of the motor 2 with different colors or different blinking patterns. The warning light 440 is turned on with any one color or blinking pattern on the basis of a control signal that is output by the processing unit 41 through the input/output unit 44.

The cut-off switch 441 is a switch that switches ON/OFF of power supply from the AC power supply E to the motor 2. In a case where it is determined that the motor 2 is in an overload state, the processing unit 41 outputs a signal for switching power supply from the AC power supply E to the motor 2 to OFF to the cut-off switch 441 from the input/output unit 44. Note that, means for stopping the motor 2 is not limited to the cut-off switch 441. The processing unit 41 may output a stoppage signal from the input/output unit 44 to a drive circuit of the motor 2.

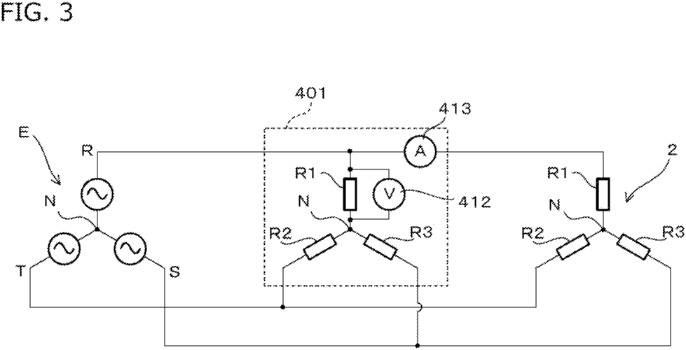

The power detection circuit 401 will be described in detail with reference to a circuit diagram. The power detection circuit 401 is designed to calculate power by using a current value and a voltage value and output the resultant value. FIG. 3 is a circuit diagram illustrating an example of a power detection circuit. In the circuit diagram in FIG. 3, the AC power supply E and the motor 2 to which the power detection circuit is connected are illustrated by an equivalent circuit.

In the circuit diagram in FIG. 3, the AC power supply E is expressed by a power supply that outputs a first-phase (R) AC voltage, a power supply that outputs a second-phase (S) AC voltage, and a power supply that outputs a third-phase (T) AC voltage of alternating current with respect to a reference voltage of a neutral point N.

In the circuit diagram in FIG. 3, the motor 2 is expressed by star-connected U-phase coil, V-phase coil, and W-phase coils having a predetermined resistance value. One end of the U-phase coil, the V-phase coil, and the W-phase coil is connected to the common neutral point N. The other end of the U-phase coil is connected to a U-phase terminal, the other end of the V-phase coil is connected to a V-phase terminal, and the other end of the W-phase coil is connected to a W-phase terminal. In the circuit diagram in FIG. 3, the U-phase coil, the V-phase coil, and the W-phase coil illustrate an example of star connection, but there is no limitation to the example, and delta connection may be employed.

The motor 2 is connected so that the first-phase (R) AC voltage of the AC power supply E is supplied to the U-phase terminal of the motor 2, the second-phase (S) AC voltage of the AC power supply E is supplied to the V-phase terminal of the motor 2, and the third-phase (T) AC voltage of the AC power supply E is supplied to the W-phase terminal of the motor 2.

The power detection circuit 401 includes resistors R1, R2, and R3 connected to contacts of respective three-phase power supply wires between the power supply connection terminal and the connection terminal of the motor 2. The resistors R1, R2, and R3 are connected to the common neutral point N in a star shape. The other end of the resistor R1 is connected to a contact between the first phase (R) of the AC power supply E and the U-phase terminal of the motor 2. The other end of the resistor R2 is connected to a contact between the second phase (S) of the AC power supply E and the V-phase terminal of the motor 2. The other end of the resistor R3 is connected to a contact between the third phase (T) of the AC power supply E and the W-phase terminal. The power detection circuit includes a voltage detection unit 412 that detects a voltage between both ends of the resistor R1, and a current detection unit 413 that detects a phase current flowing to the U-phase coil of the motor 2.

The power detection circuit 401 calculates a power factor on the basis of a phase difference between a phase voltage detected by the voltage detection unit 412 and a phase current detected by the current detection unit 413, and calculates one-phase power. The power detection circuit 401 multiplies the calculated one-phase power by three and calculates power to be supplied to the motor 2. The power detection circuit 401 outputs a signal with a signal level corresponding to a voltage value detected by the voltage detection unit 412, a signal with a signal level corresponding to a current value detected by the current detection unit 413, and a signal corresponding to calculated power to the control unit 40.

In this embodiment, description has been given on the assumption that the AC power supply E is set as the power supply of the motor 2 as illustrated in FIG. 3, but the motor 2 may be driven by an inverter.

The protection unit 400 configured as described above uses power detected by the power detection circuit 401, and a temperature inside the terminal box 4 which is detected by the temperature sensor, and estimates and calculates a gear output shaft torque (load) of the reduction gear 3 through calculation in the processing unit 41 as a value corresponding to the load of the motor 2. As a value for detecting overload of the motor 2, the output shaft torque of the motor 2 may be estimated and calculated, but the gear output shaft torque is used in this embodiment. The protection unit 400 determines a state of the motor 2 (whether or not the state is an overload state) by using a threshold value with respect to the load (torque). In a case of being determined as the overload state, the protection unit 400 stops the motor 2.

In estimation and calculation of the gear output shaft torque, gear output (power) is required. The gear output is not a detected amount, and can be calculated by subtracting a gear no-load loss from an amount (motor output) obtained by multiplying power that is input to the motor 2 and is detected by the power detection circuit 401 by motor efficiency. Here, the motor efficiency fluctuates depending on a temperature, and can be estimated from a detectable input power value. The gear no-load loss also depends on a temperature, and is not a detected amount. The gear no-load loss is obtained by multiplying the no-load torque by an output rotation speed of the motor 2. As the output rotation speed of the motor 2, the protection unit 400 may use a synchronous rotation speed that can be calculated from the number of poles of the motor by measuring a frequency of a current or a voltage. The protection unit 400 does not use the synchronization rotation speed as is, and performs calculation in consideration of motor sliding by multiplying the synchronous rotation speed by a motor load rate estimated from the input power of the motor 2.

In estimation and calculation of the gear output shaft torque, the motor efficiency, the gear temperature, the motor load rate, and the gear no-load torque are required. These depend on the input power to the motor 2 or the gear temperature. The input power and the temperature can be detected. The control unit 40 of the protection unit 400 estimates and calculates the motor efficiency, the motor load rate, and the gear no-load torque by using a relational equation (regression equation) between the input power and the temperature capable of being detected. Note that, since the temperature measured by the temperature sensor 403 is a temperature inside the terminal box 4, a relational equation between a gear grease temperature and the temperature measured inside the terminal box 4 is also obtained in advance, and the processing unit 41 estimates the gear grease temperature from a temperature obtained from the temperature sensor 403 and uses the gear grease temperature.

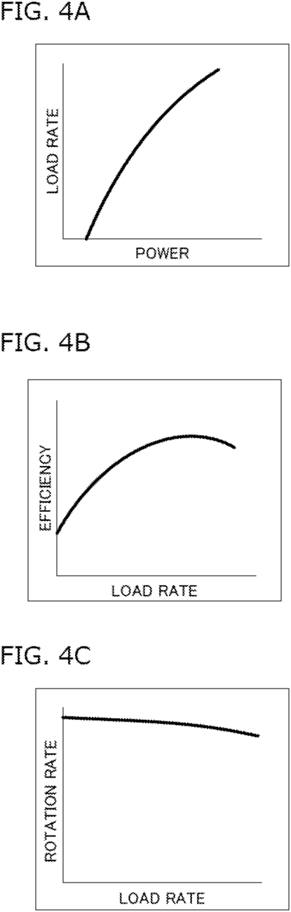

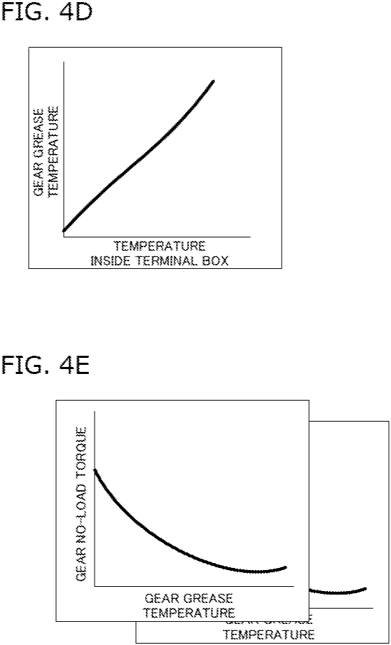

FIG. 4A to FIG. 4E schematically illustrate a regression equation stored in the storage unit. First, the regression equation includes a regression equation illustrating a relationship between the input power detected by the power detection circuit 401 and the motor load rate (FIG. 4A). The regression equation between the input power and the motor load rate as illustrated in FIG. 4A is approximated by the sum (difference) of two functions in which two factors including the input power and a power supply frequency are set as a variable. Note that, the regression equation is an equation that is appropriately set, and the number of variables, the number of terms, the degree, and the like are not limited. A mathematical formula, a coefficient, and a constant of the regression equation illustrating the relationship illustrated in FIG. 4A are stored in the storage unit 42 in advance. According to this, the processing unit 41 can estimate the motor load rate of the motor 2 at that point of time on the basis of the input power value and the power supply frequency. The power supply frequency is specified by a signal from the current detection unit 413 which is output from the power detection circuit 401. When using the regression equation in which not only the power and the power supply frequency are set as a variable, even when the motor 2 is driven by an inverter, the load (torque) of the motor 2 can be estimated and calculated with accuracy.

Second, the regression equation includes a regression equation representing a relationship between the motor load rate and the motor efficiency (FIG. 4B). The regression equation between the motor load rate and the motor efficiency as illustrated in FIG. 4B is approximately the sum of two functions in which two factors including the motor load rate and the power supply frequency are set as a variable. A mathematical formula, a coefficient, and a constant of the regression equation illustrating the relationship illustrated in FIG. 4B are stored in the storage unit 42 in advance. According to this, the processing unit 41 can estimate the motor efficiency of the motor 2 at that point of time on the basis of the motor load rate obtained by the regression equation in FIG. 4A and the power supply frequency.

Third, the regression equation includes a regression equation illustrating a relationship between the motor load rate and a motor rotation rate (FIG. 4C). The regression equation between the motor load rate and the motor rotation rate as illustrated in FIG. 4C is approximately the sum of two functions in which two factors including the motor load rate and the power supply frequency are set as a variable. A mathematical formula, a coefficient, and a constant of the regression equation illustrating the relationship illustrated in FIG. 4C are stored in the storage unit 42 in advance. According to this, the processing unit 41 can estimate the motor rotation rate of the motor 2 at that point of time on the basis of the motor load rate obtained by the regression equation in FIG. 4A and the power supply frequency. The motor rotation rate is used in estimation and calculation of the motor rotation speed.

Fourth, the regression equation includes a regression equation representing a relationship between a temperature based on a signal output from the temperature sensor and the gear grease temperature (FIG. 4D). The regression equation between the temperature and the gear grease temperature as illustrated in FIG. 4D is approximately by a function in which the temperature inside the terminal box 4 is set as a variable. A mathematical formula, a coefficient, and a constant of the regression equation illustrating the relationship illustrated in FIG. 4D are stored in the storage unit 42 in advance. According to this, the processing unit 41 can estimate the gear grease temperature of the motor 2 on the basis of the temperature inside the terminal box 4 which is obtained from the temperature sensor 403.

Fifth, the regression equation includes a regression equation illustrating a relationship between the gear grease temperature and the motor rotation speed (the number of revolutions), and the gear no-load torque for every model (FIG. 4E). The regression equation between the gear grease temperature and the gear no-load torque as illustrated in FIG. 4E is approximated by the sum of two functions in which two factors including the gear grease temperature and the motor rotation speed are set as a variable. A mathematical formula, a coefficient, and a constant of the regression equation are stored in the storage unit 42 in advance. Note that, since the relationship between the gear grease temperature and the gear no-load torque is different depending on the model, the relationship is stored for every model. According to this, the processing unit 41 can estimate the gear no-load torque on the basis of the gear grease temperature obtained by the regression equation in FIG. 4D, and the motor rotation speed obtained by multiplying the motor synchronous rotation speed by the rotation rate obtained by the regression equation in FIG. 4C.

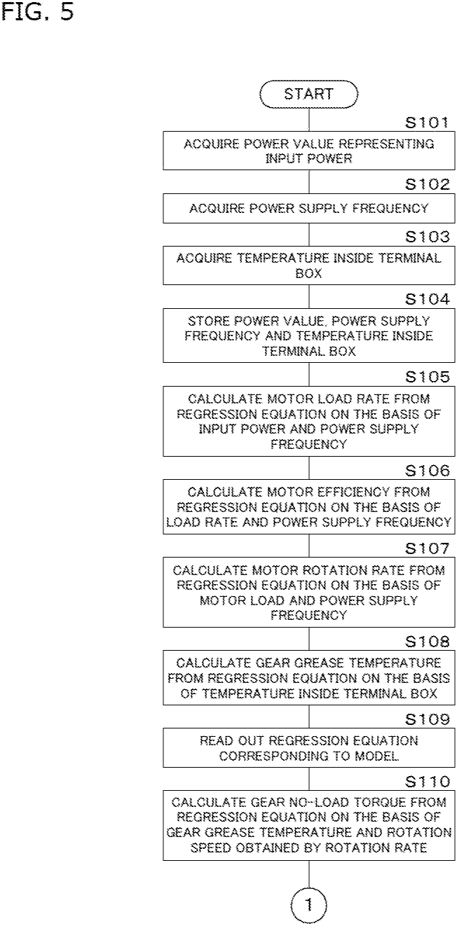

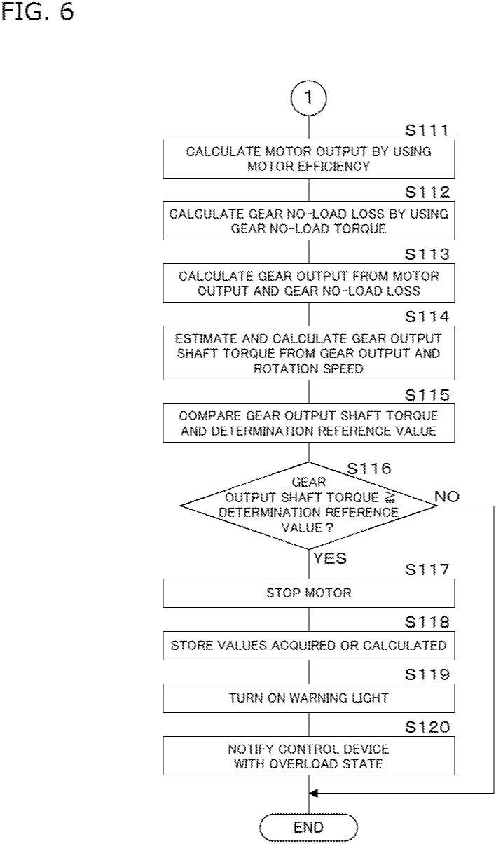

FIG. 5 and FIG. 6 are flowcharts illustrating an example of an overload detection procedure in the control unit 40 of the protection unit 400. The processing unit 41 of the control unit 40 repetitively executes the following processes until stopping power supply to the motor 2 by detecting the overload state while receiving power from the AC power supply E during operation.

The processing unit 41 acquires a power value representing input power to the motor 2 from the power detection circuit 401 through the input/output unit 44 (step S101), and acquires the power supply frequency from the current detection unit 413 (step S102).

The processing unit 41 acquires a signal indicating the temperature inside the terminal box 4 from the temperature sensor 403 through the input/output unit 44 (step S103).

The processing unit 41 temporarily stores the power value acquired in step S101, the power supply frequency acquired in step S102, and the temperature acquired in step S103 in an internal memory (step S104).

The processing unit 41 calculates the motor load rate from the regression equation (FIG. 4A) on the basis of the input power indicated by the power value obtained in step S101, and the power supply frequency acquired in step S102 (step S105).

The processing unit 41 calculates the motor efficiency from the regression equation (FIG. 4B) on the basis of the calculated motor load rate and the power supply frequency (step S106).

The processing unit 41 calculates the motor rotation rate from the regression equation (FIG. 4C) on the basis of the calculated motor load rate and the power supply frequency (step S107).

The processing unit 41 calculates the gear grease temperature from the regression equation (FIG. 4D) on the basis of the temperature acquired in step S103 (step S108).

The processing unit 41 reads out the regression equation (FIG. 4E) corresponding to a model among the regression equations (step S109).

The processing unit 41 calculates the gear no-load torque on the basis of the gear grease temperature calculated in step S107, and the motor rotation speed obtained by the rotation rate calculated in step S107 by using the regression equation read out in step S109 (FIG. 4E) (step S110).

The processing unit 41 calculates a motor output by using the motor efficiency calculated in step S106 and the power value acquired in step S 101 (step S111). The processing unit 41 calculates the gear no-load loss by using the gear no-load torque calculated in step S110, and the rotation speed acquired from the motor rotation rate calculated in step S107 (step S112).

The processing unit 41 calculates a gear output from the motor output calculated in step S111 and the gear no-load loss calculated in step S112 (step S113). The processing unit 41 estimates and calculates the gear output shaft torque by dividing the calculated gear output by the rotation speed of the motor 2 (step S114).

The processing unit 41 compares the gear output shaft torque (load of the motor 2) calculated in step S114, and a determination reference value included in the setting information 420 stored in the storage unit 42 (step S115). The processing unit 41 determines whether or not the gear output shaft torque is equal to or greater than the determination reference value from the comparison result (step S116). In step S116, the processing unit 41 may determine whether or not the output shaft torque is equal to or less than a second determination reference value lower than the determination reference value.

In step S116, in a case where the gear output shaft torque is determined as being equal to or greater than the determination reference value (S116: YES), the processing unit 41 stops the motor 2 as an overload state (step S117). The processing unit 41 stores the values acquired or calculated in steps S101 to S114 as a log in the storage unit 42 (step S118).

The processing unit 41 turns on the warning light 440 with a color or a pattern representing stoppage (step S119). The processing unit 41 notifies the control device C with stoppage of the motor 2 due to excessive torque from the communication unit (step S120), and terminates the process.

In step S116, in a case where the gear output torque is determined as being less than the determination reference (S116: NO), since a state is normal, the processing unit 41 terminates the process as is.

The determination reference value in step S116 may be one threshold value for making a determination as to whether or not overload exists. In addition to the one threshold value for making a determination as to whether overload exist, the determination reference value in step S116 may include a second threshold value smaller than the threshold value. In a case where the calculated gear no-load torque is equal to or greater than the second threshold value, the processing unit 41 may determine that overload does not exist to a certain extent of stopping the motor 2 but there is a sign of an overload state, and the control device C may be notified of this state.

Furthermore, the determination reference value (second determination reference value) in step S116 may be set to a threshold value for making a determination as to whether or not an insufficient load exists, that is, idling is caused, and the processing unit 41 may determine whether or not the gear output shaft torque is equal to or less than the determination reference value in step S116.

Description has been given to a configuration in which the values acquired or calculated in steps S101 to S114 are stored in the storage unit 42 in step S118, but at least the acquired input power value, the temperature, and the calculated gear output shaft torque may be stored in combination with information representing an excessive (or insufficient) torque, for example, an error code. In this case, the excessive (or insufficient) torque can be specified by reading out the error code from the control device C that is notified of stoppage of the motor 2, or a device for maintenance. Alternatively, the error code corresponding to the “excessive torque” (or “insufficient torque”) may be included in the notification in step S120. The lighting color or pattern in step S119 may represent the “excessive torque” (or “insufficient torque”).

Note that, the protection unit 400 executes a process of detecting abnormality on the basis of a signal representing vibration which is obtained from the vibration sensor 402 in combination with the procedure shown in the flowcharts in FIG. 5 and FIG. 6. In a case where abnormality based on the vibration is detected, the processing unit 41 of the protection unit 400 stops the motor 2, and turns on the warning light 440 to notify the control device C of stoppage of the motor 2 due to vibration abnormality. The protection unit 400 can distinguish whether the motor 2 is stopped due to detection of the abnormal vibration, or whether the motor 2 is stopped due to the overload state or the light load state.

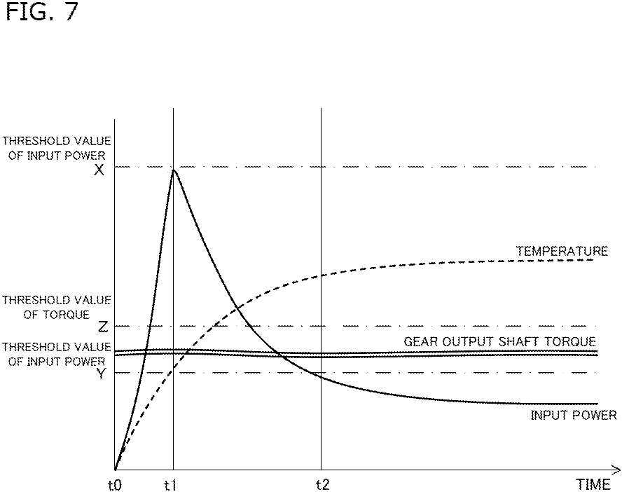

The procedure illustrated in the flowcharts in FIG. 5 and FIG. 6 will be described in detail. FIG. 7 is a graph illustrating an example of the input power, the gear grease temperature, and the gear output shaft torque in the motor 2 with passage of time. In the graph in FIG. 7, the horizontal axis represents passage of time, and the vertical axis represents the magnitude of input power, a temperature, and a torque value. The graph in FIG. 7 illustrates a transition of the input power with a solid line, represents a transition of the temperature with a broken line, and represents a transition of the torque by a double line. The graph in FIG. 7 illustrates temporal variation of values in a state in which the motor device 1 that is a gear motor operates normally and is not overloaded.

In the motor device 1 that starts to operate at time t0, the input power increases while the motor 2 is accelerated. Up to time t1, the power reaches a peak. A temperature is a relatively low up to the time t1. In this case, in only the power value, although an actual load is within a permissible range, there is a possibility that determination may be made as overload depending on a specific value of a threshold value that is set to the power value.

Gear efficiency greatly varies depending on a temperature. The reason why the input power is large as at time t1 is because the temperature is low and the gear efficiency is low, and the load is not necessarily large.

After time t1, the temperature gradually approaches an arbitrary temperature. Time passes from initiation of operation, and for example, the temperature becomes relatively high at time t2. In this state, the gear efficiency is high, and it enters a state in which the load is large as the input power increases.

When considering that the motor device 1 takes the course of the input power and the temperature as illustrated in FIG. 7, in a method of detecting overload by setting a threshold value with respect to the input power, detection is difficult. For example, in a case where a value X in FIG. 6 is set as a threshold value for overload detection with respect to the input power value, after the temperature rises and the input power decreases from a peak at the time t1, even when the input power value increases in an overload state in the vicinity of the time t2, the overload state cannot be detected. On the contrary, for example, in a case where a value Y in FIG. 6 is set as the threshold value, there is a possibility that a normal state immediately after initiation of operation up to the time t2 may be erroneously detected as the overload state.

In contrast, as illustrated in the flowcharts in FIG. 5 and FIG. 6, in the protection unit 400 of the present disclosure, the gear output shaft torque is estimated on the basis of an input power and a temperature which can be detected. The output shaft torque is a value corresponding to an output shaft torque of the motor 2, that is, a load of the motor 2, and the output shaft torque is calculated to be high in a low temperature state, and decreases at a high temperature. Accordingly, as illustrated in FIG. 7, the gear output shaft torque is calculated to be nearly constant under normal conditions when being compared with a variation of the temperature and a transition of the input power. In this manner, the protection unit 400 can more accurately detect overload or light load in consideration of a fluctuation of the gear efficiency due to a temperature while using an input power value obtained from the power detection circuit 401.

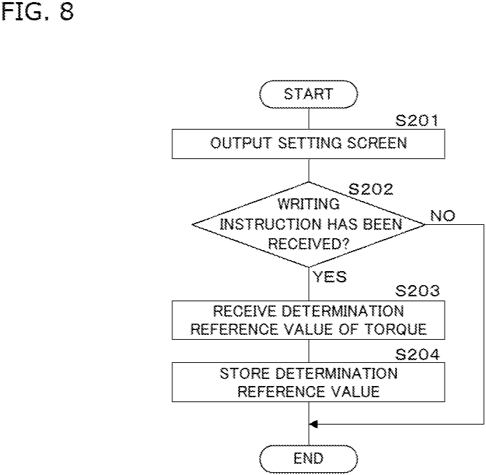

The determination reference value (S116) for detecting an overload state with respect to an estimated load value (in this embodiment, the gear output shaft torque) is stored in the storage unit 42. With regard to the threshold value, the protection unit 400 can accept setting from the outside through the communication unit 43. FIG. 8 is a flowchart illustrating an example of a procedure of accepting setting of the determination reference value by the control unit 40.

The processing unit 41 of the control unit 40 executes the following process in a case of receiving a setting request through the communication unit 43. Specifically, in a case where a device for maintenance other than the control device C is connected through the communication unit 43, the processing unit 41 detects the connection.

The processing unit 41 outputs a setting screen on the basis of a setting program incorporated in the control program 4P (step S201). The processing unit 41 determines whether or not a writing instruction for the determination reference value related to a torque has been received on the setting screen (step S202). In a case where it is determined that the writing instruction has been received (S202: YES), the processing unit 41 receives the determination reference value transmitted in combination with the instruction (step S203), and writes the determination reference value in the setting information 420 (step S204), and terminates the acceptance process.

In a case where it is determined that the writing instruction is not received (S202: NO), the processing unit 41 terminates the acceptance process as is.

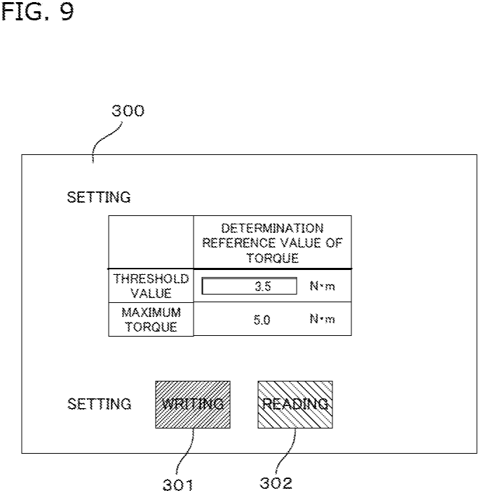

FIG. 9 is a view illustrating an example of an acceptance screen 300 for setting of the determination reference value. With regard to the acceptance screen 300 in FIG. 9, the processing unit 41 reads out screen data from the storage unit 42, and outputs the screen data to the device for maintenance which is connected through the communication unit 43. The acceptance screen 300 includes a text box for accepting input of a threshold value. With respect to the threshold value, the acceptance screen 300 displays maximum load data in the motor device 1 to which the protection unit 400 is attached to be written in combination with the input threshold value.

The acceptance screen 300 includes a “writing” button 301 and a “reading” button 302. In a case where the “writing” button 301 is selected, a writing instruction is transmitted from the device for maintenance to the protection unit 400 in combination with a threshold value indicated by a text accepted by the text box of the acceptance screen 300. In a case where the “reading” button 302 is selected, a content of the setting information 420 is transmitted from the protection unit 400 to the device for maintenance. According to this, the content of the setting information 420 in the protection unit 400 can be confirmed from the device for maintenance, and it is possible to perform setting of a determination reference value for an appropriate load corresponding to a model of the motor device 1 and a use environment of the motor device 1. This is also true of setting of a determination reference value (second determination reference value) for light load.

In the above-described embodiment, the gear output shaft torque is derived by using the first to fifth regression equations in accordance with the procedure illustrated in the flowcharts in FIG. 5 and FIG. 6. However, the output shaft torque of the motor 2 may be derived by the first to third regression equations. The gear output shaft torque may be derived by using only a part of the first to fifth regression equations. For example, with regard to the temperature, the processing unit 41 may use the temperature as is or may use a value obtained by multiplying the temperature measured by the temperature sensor by a specific coefficient. The processing unit 41 may use a synchronous rotation speed as the rotation speed. In addition, the processing unit 41 may derive the output shaft torque of the motor 2 by combining a physical quantity derived by another calculation method.

In the above-described embodiment, description has been given of a method of obtaining the load (torque) with reference to an example in which the motor device 1 is a gear motor. The motor device 1 is not limited to the gear motor, and a motor 2 that is not provided with the reduction gear may be used. In this case, the protection unit 400 may estimate and calculate the load from the number of revolutions or the like by using a regression equation for deriving the output shaft torque of the motor 2, or may estimate the motor output shaft torque from a torque in a mechanism (gear or the like) provided in the output of the motor 2 and may use the motor output shaft torque.

As described, the disclosed embodiment is illustrative only in all aspects, and is not restrictive. The scope of the invention is represented by the appended claims, and includes meaning equivalent to the appended claims and all modifications in the scope.

1-14. (canceled)

15. A motor device, comprising:
a motor;
a power detection circuit that detects power supplied to the motor;
a temperature sensor that measures a temperature of the motor;
a storage unit that stores a regression equation representing a relationship between power detected by the power detection circuit and a temperature measured by the temperature sensor, and a physical quantity used to derive an output shaft torque of the motor; and
a processing unit that derives the output shaft torque of the motor from the power detected by the power detection circuit and the temperature measured by the temperature sensor by using the physical quantity obtained by the regression equation.

16. The motor device according to claim 15,
wherein the regression equation includes,
a first regression equation representing a relationship between power detected by the power detection circuit, and a load rate of the motor,
a second regression equation representing a relationship between the load rate and motor efficiency of the motor, and
a third regression equation representing a relationship between the load rate and a rotation rate with respect to a synchronous rotation speed of the motor, and
the processing unit derives the output shaft torque of the motor by using,
motor efficiency obtained from power detected by the power detection circuit on the basis of the second regression equation, and a motor output obtained from the motor efficiency, and
a rotation rate obtained from the power on the basis of the third regression equation, and a rotation speed of the output shaft of the motor which is obtained by the rotation rate.

17. The motor device according to claim 15,
wherein the processing unit compares the derived output shaft torque of the motor and a determination reference value with each other, and stops the motor in a case where the output shaft torque is determined as being equal to or greater than the determination reference value.

18. The motor device according to claim 15,
wherein the processing unit compares the derived output shaft torque of the motor and a determination reference value with each other, and stops the motor in a case where the output shaft torque is determined as being equal to or less than the determination reference value.

19. The motor device according to claim 15, further comprising:
a communication unit,
wherein the processing unit compares the derived output shaft torque of the motor and a determination reference value with each other, and notifies the outside of an overload state of the motor in combination with data representing an excessive output shaft torque by the communication unit in a case where the output shaft torque is determined as being equal to or greater than the determination reference value.

20. The motor device according to claim 15, further comprising:
a communication unit,
wherein the processing unit compares the derived output shaft torque of the motor and a determination reference value with each other, and notifies the outside of a light load state of the motor in combination with data representing an insufficient output shaft torque by the communication unit in a case where the output shaft torque is determined as being equal to or less than the determination reference value.

21. The motor device according to claim 15, further comprising a communication unit,
wherein the processing unit notifies the outside of data corresponding to the magnitude of the derived output shaft torque of the motor by the communication unit.

22. The motor device according to claim 16,
wherein one or a plurality of the first to third regression equations use a power supply frequency of the power supply which is specified on the basis of a signal detected by a current detection unit included in the power detection circuit.

23. The motor device according to claim 18,
wherein the processing unit accepts setting of the determination reference value.

24. A gear motor, comprising:
a motor;
a reduction gear that reduces and outputs rotation of the motor;
a power detection circuit that detects power supplied to the motor;
a temperature sensor that measures a temperature of the motor;
a storage unit that stores a regression equation representing a relationship between power detected by the power detection circuit or a temperature measured by the temperature sensor, and a physical quantity used to derive a gear output shaft torque of the reduction gear; and
a processing unit that derives the gear output shaft torque of the reduction gear from the power detected by the power detection circuit or the temperature measured by the temperature sensor by using the physical quantity obtained by the regression equation.

25. The gear motor according to claim 24,
wherein the regression equation includes a fourth regression equation representing a relationship between a temperature measured by the temperature sensor, and a gear grease temperature of the reduction gear, and
the processing unit derives the output shaft torque of the reduction gear by deriving the gear grease temperature from a temperature measured by the temperature sensor by using the fourth regression equation.

26. The gear motor according to claim 24,
wherein the regression equation includes a fifth regression equation representing a relationship between a temperature of the motor, and a no-load torque of the reduction gear, and
the processing unit derives the output shaft torque of the reduction gear by using a no-load loss of the motor which is obtained by the no-load torque obtained from the temperature by using the fifth regression equation and a rotation speed of the motor, a motor output obtained on the basis of power detected by the power detection circuit, and a rotation speed of an output shaft of the motor.

27. The gear motor according to claim 25,
wherein the temperature sensor is accommodated in a box attached to an exterior package of the motor, and
the fourth regression equation is a regression equation representing a relationship between an inner temperature of the box and the lubricant temperature.

28. The gear motor according to claim 26,
wherein the fifth regression equation includes a plurality of regression equations representing different relationships in accordance with a model of the motor, and
the processing unit selects the fifth regression equation in correspondence with the model of the motor.

29. A detection method of a motor load state, comprising:
acquiring power supplied from a power supply to a motor;
acquiring a temperature of the motor;
storing a regression equation representing a relationship between the power supplied to the motor and the temperature of the motor, and a physical quantity used to derive an output shaft torque of the motor;
deriving the output shaft torque of the motor from the acquired power and the acquired temperature by using the regression equation;
determining whether or not the derived output shaft torque is equal to or greater than a determination reference value;
detecting that the motor is in an overload state in a case where the output shaft torque is determined as being equal to or greater than the determination reference value.

30. A detection method of a motor load state, comprising:
acquiring power supplied from a power supply to a motor;
acquiring a temperature of the motor;
storing a regression equation representing a relationship between the power supplied to the motor and the temperature of the motor, and a physical quantity used to derive an output shaft torque of the motor;
deriving the output shaft torque of the motor from the acquired power and the acquired temperature by using the regression equation;
determining whether or not the derived output shaft torque is equal to or less than the determination reference value; and
detecting that the motor is in a light load state in a case where the output shaft torque is determined as being equal to or less than the determination reference value.

31. A computer readable medium storing a computer program of detecting a motor load state, the computer program causing a computer to execute processes of:
acquiring power supplied from a power supply to a motor;
acquiring a temperature of the motor;
storing a regression equation representing a relationship between the power supplied to the motor and the temperature of the motor, and a physical quantity used to derive an output shaft torque of the motor; and
deriving the output shaft torque of the motor from the acquired power and the acquired temperature by using a physical quantity obtained by the regression equation.
